(19) United States
(12) Patent Application Publication
(10) Pub. No.: US 2024/0111074 A1
(43) Pub. Date: Apr. 4, 2024

(54) BIAS CORRECTION AND STATISTICAL DOWNSCALING OF OCEAN CLIMATE SYSTEMS

(71) Applicant: Actea, Inc., San Francisco, CA (US)

(72) Inventors: Trond Kristiansen, San Francisco, CA (US); Jordan Hood Miller, San Francisco, CA (US)

(21) Appl. No.: 18/475,263

(22) Filed: Sep. 27, 2023

Related U.S. Application Data
(60) Provisional application No. 63/378,054, filed on Oct. 1, 2022.

(51) Int. Cl. G01W 1/10

(52) U.S. Cl. CPC G01W 1/10

(57) ABSTRACT

The disclosed embodiments provide a technique for processing ocean climate data. The technique converts the ocean climate data into one or more climatology components and one or more anomaly time series. The technique also trains one or more bias correction techniques using the one or more anomaly time series and generates, using the one or more trained bias correction techniques, an anomaly projection of the ocean climate data onto a future time period. The technique further includes generating a climate projection for the future time period using the anomaly projection and the one or more climatology components and causing a visual representation of the climate projection for a geographic region associated with the ocean climate data to be outputted.

### RELATED APPLICATION

This application claims the benefit of U.S. Provisional Application No. 63/378,054, Attorney Docket Number ACTE.0001L, entitled “Statistical Downscaling of Ocean Climate Systems,” by inventors Trond Kristiansen and Jordan H. Miller, filed Oct. 1, 2022, which is incorporated herein by reference.

### BACKGROUND

### Field

The disclosed embodiments relate to climate modeling. More specifically, the disclosed embodiments relate to techniques for performing bias correction and statistical downscaling of ocean climate systems.

### Related Art

Climate models are complex representations of major climate system components and the interactions among these system components. For example, a climate model can include an atmospheric component that simulates clouds and aerosols and affects the transport of heat and water around the globe. The climate model can also include a land surface component that simulates attributes such as vegetation, snow cover, soil water, rivers, and carbon sequestration. The climate model can further include an ocean component that simulates the movement and mixing of currents as well as chemical, physical, geological, and biological processes and reactions that govern the composition of the natural environment. The climate model can additionally include a sea ice component that modulates solar radiation absorption and air-sea heat and water exchanges.

Climate models include global climate models (GCMs) that divide the globe into a three-dimensional (3D) grid of cells representing specific geographic locations and elevations. Each system component includes equations that are used to compute climate variables, such as temperature over time, on the global grid, at a typical resolution of around hundreds of kilometers. The system components also interact with one another as a coupled system.

Climate models also include regional climate models (RCMs) that simulate interactions between large-scale weather patterns represented by GCMs and local terrain and conditions. RCMs typically operate at resolutions of tens of kilometers and can be used to study natural variations in climate, determine the effects of human activity (e.g., agriculture, deforestation, etc.) on regional weather patterns, and/or predict the effects of climate change on human habitats and/or other environments. However, because RCMs can be computationally intensive, RCM output can be unavailable for certain regions.

To address the unavailability of RCM output and/or increase the resolution associated with a GCM, downscaling of GCM data can be performed. For example, downscaling of a climate model can be performed to determine and/or predict flood risk, wildfire risk, habitat quality, and/or other climate change or environmental impacts for a given geographic region.

In general, climate model downscaling can be divided into two broad categories. The first category is referred to as dynamic downscaling and uses RCMs to extrapolate the effects of large-scale climate processes to regional or local scales. The second category is referred to as statistical downscaling and leverages statistical relationships between observed and/or analyzed large-scale atmospheric variables and local and/or regional climate variables to predict local climate conditions.

However, existing downscaling techniques have been developed using atmospheric datasets for the purposes of conducting land-based analyses of resources, activities, and/or infrastructure. These downscaling methodologies cannot be directly applied to oceanic data for a number of reasons. First, because oceans are vast and largely unpopulated, oceanic data is much less spatially and temporally frequent than atmospheric data. For example, atmospheric statistical downscaling can treat each calendar month across multiple years as an independent dataset because daily meteorological data collected over a multi-decade period results in hundreds of observations for each calendar month. On the other hand, ocean datasets are frequently limited to only one observation per month over a comparable multi-year period, which is insufficient for training and validating a separate statistical downscaling model for each calendar month.

Second, direct observations can only be made of the surface layer of the ocean, thereby limiting the ability to assess deeper thermal, chemical, or biological dynamics. Third, traditional downscaling methodologies typically do not account for the unique physical properties of oceans, such as greater thermal mass, marine circulations, or upwellings.

Consequently, climate modeling can be improved via effective techniques for downscaling oceanic data.

### BRIEF DESCRIPTION OF THE FIGURES

FIG. 1 shows a computer system in accordance with the disclosed embodiments.

FIG. 2 shows a system for performing bias correction and statistical downscaling of ocean climate systems in accordance with the disclosed embodiments.

FIG. 3 illustrates an example process for performing grid standardization of ocean climate data in accordance with the disclosed embodiments.

FIG. 4A illustrates an example process for performing trend-preserving climatology removal in ocean climate data in accordance with the disclosed embodiments.

FIG. 4B illustrates an example process for generating a high-resolution climate projection from ocean climate data in accordance with the disclosed embodiments.

FIG. 5 shows a flowchart of method steps for processing ocean climate data in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

As discussed above, existing downscaling techniques leverage atmospheric datasets for the purposes of conducting land-based analyses of resources, activities, and/or infrastructure. As a result, these downscaling techniques cannot be directly applied to oceanic data because oceanic data is much less spatially and temporally frequent than atmospheric data, direct observations can only be made of the surface layer of the ocean, and traditional downscaling methodologies typically do not account for unique physical properties of oceans.

To address the above limitations, the disclosed embodiments provide a technique for performing bias correction and statistical downscaling of ocean climate systems. The ocean climate systems can be represented by one or more lower-resolution climate projection datasets and one or more higher-resolution observational datasets. The spatial resolution and/or coordinate system associated with each dataset can be upsampled and/or downsampled using spherical grid extrapolation and regridding techniques. Next, a trend-preserving climatology removal process is used to aggregate relatively sparse (e.g., monthly) data points that span multiple years within the datasets into an anomaly time series that spans a month. During the trend-preserving climatology removal process, trend and climatology components can be removed from a given set of data points to generate a trendless anomaly time series. The trend component can then be added back to the trendless anomaly time series to produce a corresponding trend-preserved anomaly time series that is compatible with a bias correction and/or statistical downscaling technique.

Anomaly time series generated from the climate projection dataset(s) and observational dataset(s) are used to train the bias correction and/or statistical downscaling technique. During the training process, parameters that model relationships between the climate projection dataset(s) and the observational dataset(s) are learned. After the training process is complete, the parameters are used by an inference process to generate an anomaly projection from data points that span a future time period within the climate projection dataset(s). A climatology addition process that is a reverse of the trend-preserving climatology removal process is then performed to convert the anomaly projection into a climate projection. Finally, the climate projection can be used to generate a visualization and/or perform habitat analysis, impact analysis, and/or other types of analyses related to the ocean climate data.

Advantageously, the disclosed embodiments adapt bias correction and statistical downscaling techniques that have been developed for land-based analyses to relatively sparse ocean climate data. The disclosed embodiments thus improve the functionality and accuracy of computer-based tools and technologies for performing bias correction, statistical downscaling, and/or climate modeling, relative to conventional methods that are incompatible with ocean climate data. Additionally, because the disclosed embodiments are capable of processing relatively sparse ocean climate data, the disclosed embodiments are more efficient and incur less overhead than conventional atmospheric statistical downscaling techniques that process much larger volumes of atmospheric data. This reduced resource overhead additionally allows a large number of models and scenarios to be assessed using the disclosed techniques, thereby improving understanding of inter-model variability in climate models, downscaling models, and/or bias correction techniques.

### Bias Correction and Statistical Downscaling of Ocean Climate Systems

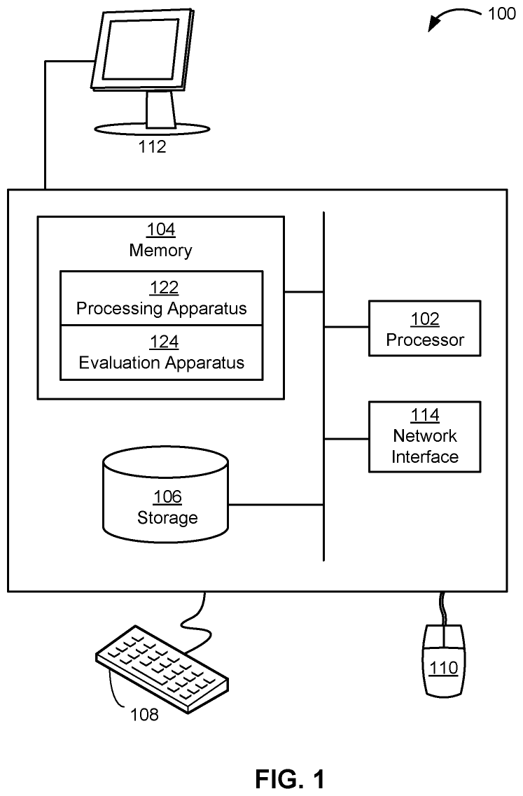

FIG. 1 shows a computer system 100 within which the disclosed embodiments can be implemented. Computer system 100 includes a processor 102, a memory 104, a storage 106, a network interface 114, and/or other components found in electronic computing devices. For example, computer system 100 may include (but is not limited to) a desktop computer, a laptop computer, a mobile phone, a personal digital assistant (PDA), a tablet computer, a game console, a smart home device, a server, a workstation, a virtual machine, and/or another arrangement of hardware and/or software components that can be configured to implement one or more disclosed embodiments.

Processor 102 may support parallel processing and/or multi-threaded operation within computer system 100. For example, processor 102 includes (but is not limited to), a central processing unit (CPU), graphics-processing unit (GPU), field programmable gate array (FPGA), application-specific integrated circuit (ASIC), artificial intelligence (AI) accelerator, another type of processing unit, and/or a combination of different processing units (e.g., a CPU operating in conjunction with a GPU).

Memory 104 includes cache memory, dynamic random-access memory (“DRAM”), video random-access memory (“VRAM”), non-volatile memory (e.g., flash memory), and/or other components that can store data. As shown in FIG. 1, memory 104 includes a processing apparatus 122 and an evaluation apparatus 124.

Storage 106 includes non-volatile storage for applications and data. For example, storage 106 may include one or more fixed and/or removable hard disk drives, solid state drives, flash memory devices, CD-ROMs (compact disc read-only-memories), DVD-ROMs (digital versatile disc-ROMs), and/or other magnetic, optical, or solid-state storage devices. Processing apparatus 122 and evaluation apparatus 124 can be stored in storage 106 and loaded into memory 104 when executed. The operation of processing apparatus 122 and evaluation apparatus 124 is described in further detail below.

Computer system 100 also includes input/output (I/O) devices such as (but not limited to) a keyboard 108, a mouse 110, and a display 112. Each I/O device can be capable of receiving input from a user and/or generating output to the user.

Network interface 114 includes hardware and/or software components that connect computer system 100 to a public and/or private network. For example, network interface 114 may include a network interface card (NIC), a virtual network interface (VNI), and/or another representation of an interface between computer system 100 and a network (not shown). The network may include (but is not limited to) a local area network (LAN), wide area network (WAN), personal area network (PAN), virtual private network, intranet, cellular network, Wi-Fi network (Wi-Fi® is a registered trademark of Wi-Fi Alliance), Bluetooth (Bluetooth® is a registered trademark of Bluetooth SIG, Inc.) network, universal serial bus (USB) network, Ethernet network, and/or switch fabric.

Computer system 100 includes functionality to execute various components of the present embodiments. In particular, computer system 100 includes an operating system (not shown) that coordinates the use of hardware and software resources on computer system 100, as well as one or more applications that perform specialized tasks for the user. To perform tasks for the user, applications obtain the use of hardware resources on computer system 100 from the operating system and interact with the user through a hardware and/or software framework provided by the operating system.

In addition, one or more components of computer system 100 may be remotely located and connected to the other components over a network. Portions of the present embodiments (e.g., processing apparatus 122, evaluation apparatus 124, etc.) may also be located on different nodes of a distributed system that implements the embodiments. For example, the present embodiments may be implemented using a distributed and/or cloud computing system that coordinates and/or manages the execution of remote tasks performed by processing apparatus 122 and/or evaluation apparatus 124. In another example, one or more instances of processing apparatus 122 and/or evaluation apparatus 124 may execute on various sets of hardware, types of devices, and/or environments to adapt processing apparatus 122 and/or evaluation apparatus 124 to different use cases or applications. In a third example, processing apparatus 122 and evaluation apparatus 124 may execute on different computer systems and/or different sets of computer systems.

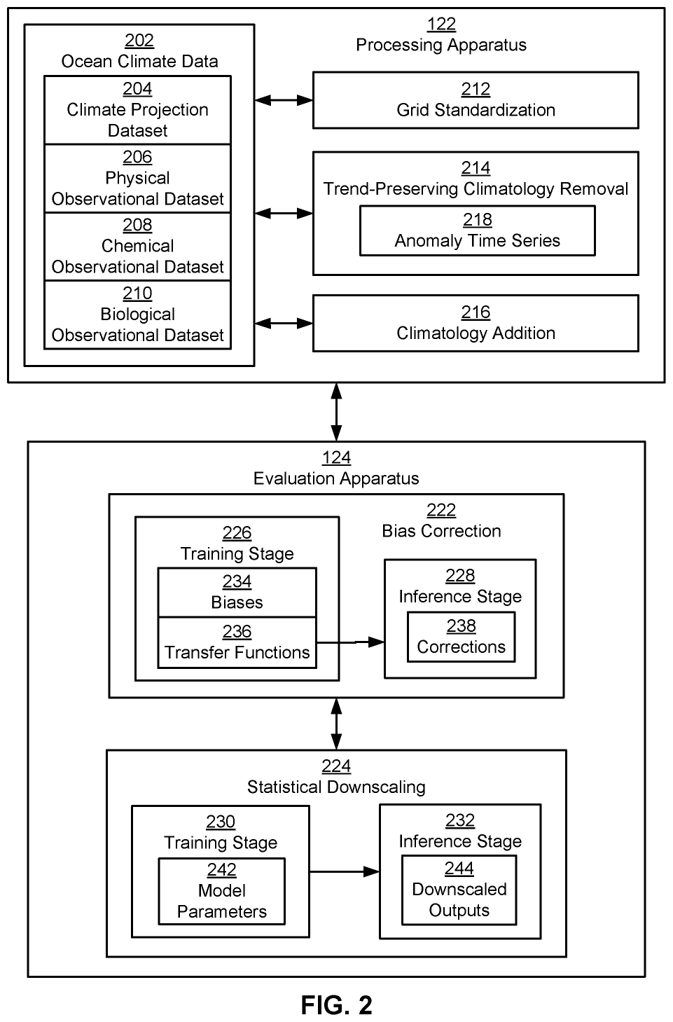

FIG. 2 shows a system for performing bias correction and statistical downscaling of ocean climate systems in accordance with the disclosed embodiments. As shown in FIG. 2, the system includes processing apparatus 122 and evaluation apparatus 124. Each of these components is described in further detail below.

Processing apparatus 122 performs various types of processing related to ocean climate data 202. This processing includes grid standardization 212, trend-preserving climatology removal 214, and climatology addition 216. Evaluation apparatus 124 performs various analyses using ocean climate data 202, including (but not limited to) bias correction 222 and statistical downscaling 224. These analyses can be performed in conjunction with and/or separately from any processing of ocean climate data 202 performed by processing apparatus 122.

In some embodiments, ocean climate data 202 includes various datasets and/or types of data that can be used to perform climate modeling. For example, ocean climate data 202 may include datasets derived from global climate models (GCMs), reanalyses, and/or other sources. As shown in FIG. 2, ocean climate data 202 includes a climate projection dataset 204, a physical observational dataset 206, a chemical observational dataset 208, and a biological observational dataset 210.

Climate projection dataset 204 includes climate model outputs that can be used to predict a future climate over temporal and/or spatial scales. For example, climate projection dataset 204 may be derived from one or more GCMs and/or Earth system models (ESMs). Data points in climate projection dataset 204 may include (but are not limited to) historical sea surface temperatures, salinity, ocean circulation patterns, and/or sea-level changes. Data points in climate projection dataset 204 may also, or instead, include projections that are based on different greenhouse gas emission scenarios (e.g., Representative Concentration Pathways (RCPs) scenarios).

Physical observational dataset 206 includes direct and indirect measurements and observations of physical attributes of oceanic systems. For example, data points in physical observational dataset 206 may include (but are not limited to) measurements of ocean temperatures, current velocity, light irradiance, sea ice thickness, sea ice concentration, and/or other variables representing physical attributes of ocean environments. Consequently, physical observational dataset 206 can be used to determine trends and patterns in the physical properties of ocean environments.

Chemical observational dataset 208 includes measurements of chemical composition and properties of ocean waters. For example, data points in chemical observational dataset 208 may include (but are not limited to) salinity, pH, concentrations of dissolved gases (e.g., carbon dioxide, oxygen, etc.), and/or nutrient levels (e.g., nitrate, phosphate, silicate, etc.). These measurements can be used to understand processes such as ocean acidification, nutrient cycling, and carbon sequestration.

Biological observational dataset 210 includes data related to the presence, abundance, distribution, and/or diversity of various marine species. For example, biological observational dataset 210 may include (but is not limited to) measurements and/or observations associated with variables representing chlorophyll, phytoplankton, primary production, zooplankton, eutrophication, oligotrophic environments, and/or water quality. Biological observational dataset 210 can thus be used to assess climate change and/or other impacts on marine biodiversity, fisheries, and/or habitat health.

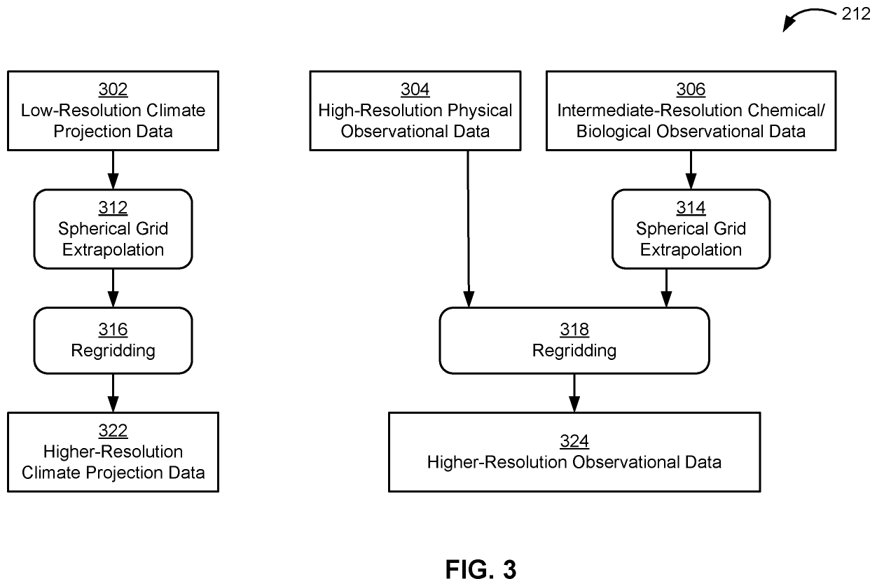

As mentioned above, processing apparatus 122 includes functionality to perform grid standardization 212, trend-preserving climatology removal 214, and climatology addition 216 on ocean climate data 202. In some embodiments, processing apparatus 122 performs grid standardization 212 on ocean climate data 202 before trend-preserving climatology removal 214 and climatology addition 216. As described in further detail below with respect to FIG. 3, grid standardization 212 includes converting spatial resolutions and/or coordinate systems associated with one or more datasets in ocean climate data 202 (e.g., climate projection dataset 204, physical observational dataset 206, chemical observational dataset 208, biological observational dataset 210, etc.) into a prespecified “standard” spatial resolution and/or coordinate system.

After grid standardization 212 is complete, processing apparatus 122 performs trend-preserving climatology removal 214 using ocean climate data 202 to which grid standardization 212 has been applied. For example, processing apparatus 122 may apply trend-preserving climatology removal 214 to climate projection dataset 204, physical observational dataset 206, chemical observational dataset 208, and/or biological observational dataset 210 after spherical grid extrapolation and/or regridding have been used to convert some or all datasets into one or more standardized spatial resolutions and/or coordinate systems.

Those skilled in the art will appreciate that physical observational dataset 206, chemical observational dataset 208, and/or biological observational dataset 210 in ocean climate data 202 may include observational data points that are collected at monthly intervals (i.e., 12 per year) over a number (e.g., 30) of years. Because these data points are significantly less frequent than atmospheric and/or meteorological observations that are collected on a daily basis over a comparable number of years, ocean climate data 202 cannot be used with conventional techniques that perform statistical downscaling on data points that span individual calendar months of the year (e.g., because observational ocean climate data 202 that is collected once a month is insufficient for training and validating a conventional statistical downscaling model for a given calendar month).

In one or more embodiments, processing apparatus 122 uses trend-preserving climatology removal 214 to convert relatively sparse ocean climate data 202 into a form that can be used with bias correction 222 and/or statistical downscaling 224 techniques. More specifically, processing apparatus 122 can aggregate observational data points from a given observational dataset (e.g., physical observational dataset 206, chemical observational dataset 208, biological observational dataset 210, etc.) into a time series that spans a single month. For example, processing apparatus 122 may accumulate for a given variable within an observational dataset, 360 observational data points collected at monthly intervals over a 30-year period into a time series that spans a single month. Within the time series, the data points are ordered by the day of the month in which the data points were collected.

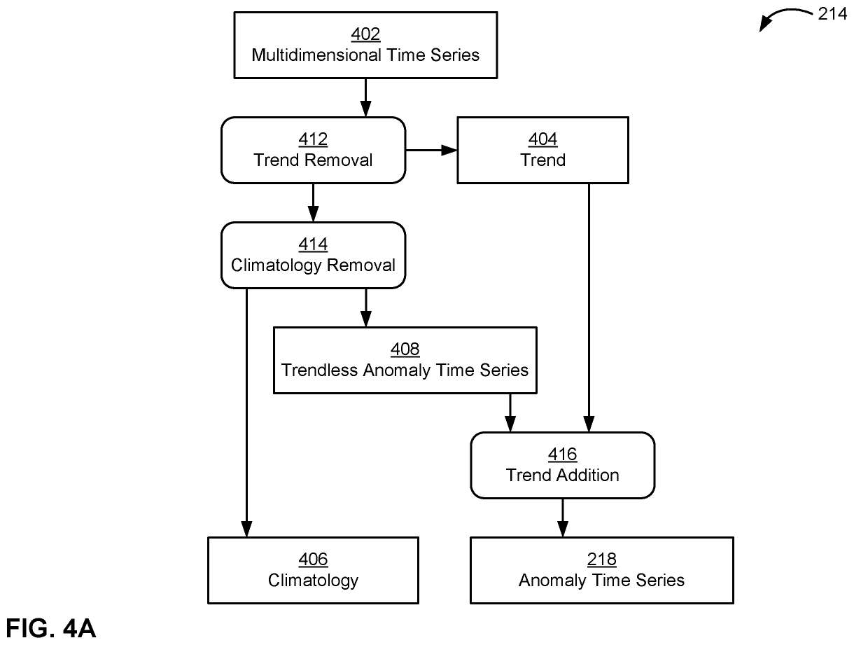

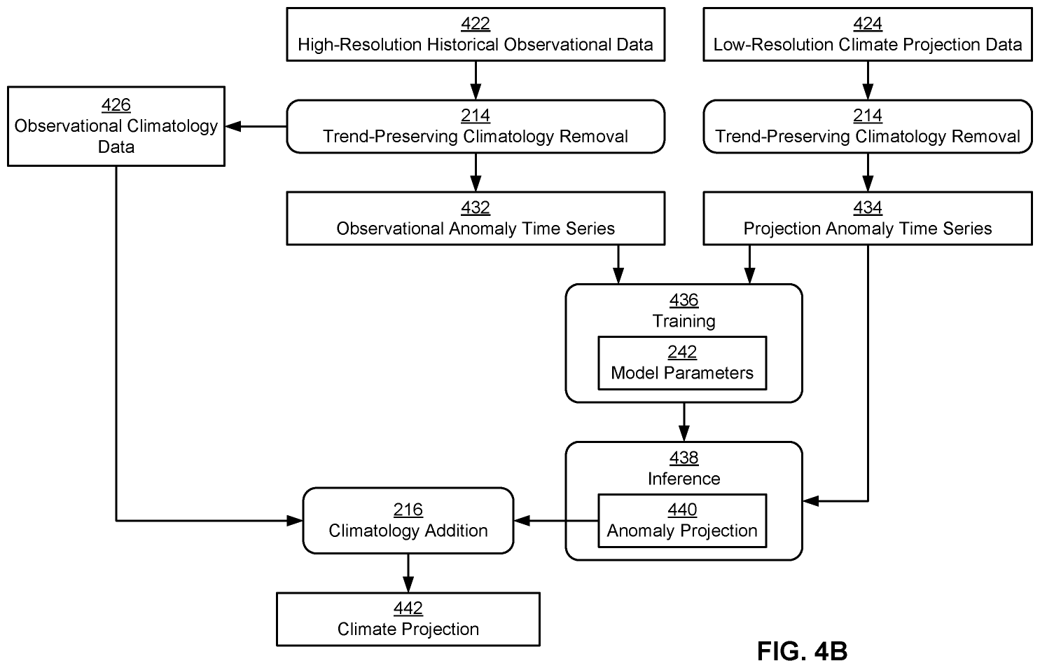

To combine observational data points that span multiple years into a single month, processing apparatus 122 uses trend-preserving climatology removal 214 to convert the time series into an anomaly time series 218. As described in further detail below with respect to FIG. 4A, trend-preserving climatology removal 214 involves removing trend components and climatology components from the time series to generate a trendless anomaly time series, then adding the trend component back to the trendless anomaly time series to generate a trend-preserved anomaly time series 218.

Anomaly time series 218 can then be used by evaluation apparatus 124 to perform bias correction 222 and/or statistical downscaling 224. As shown in FIG. 2, bias correction 222 includes a training stage 226 and an inference stage 228, and statistical downscaling 224 separately includes a training stage 230 and an inference stage 232.

Bias correction 222 involves adjusting distributional biases 234 in climate projection dataset 204 to reflect observational data points in one or more observational datasets (e.g., physical observational dataset 206, chemical observational dataset 208, and/or biological observational dataset 210). During training stage 226, evaluation apparatus 124 estimates biases 234 in climate projection dataset 204 by comparing statistics for historical data in climate projection dataset 204 with corresponding statistics for historical data in the observational dataset(s). Evaluation apparatus 124 also determines one or more transfer functions 236 that can be used to reduce biases 234 in climate projection dataset 204. For example, transfer functions 236 may include a linear, nonlinear, polynomial, quantile-based, machine-learning-based, and/or another type of function that maps between historical data points in climate projection dataset 204 and historical data points in the observational dataset(s). Evaluation apparatus 124 can also use transfer functions 236 to correct for biases 234 in historical data points in climate projection dataset 204.

During inference stage 228, evaluation apparatus 124 uses transfer functions 236 to make corrections 238 to data points spanning future periods within climate projection dataset 204. For example, evaluation apparatus 124 may use transfer functions 236 to adjust quantiles associated with one or more future periods in climate projection dataset 204 so that the distribution of data spanning the future period(s) better matches the distribution of data in the observational dataset(s).

Statistical downscaling 224 involves increasing the spatial resolution of climate projection dataset 204 to match that of observational data points in one or more observational datasets (e.g., physical observational dataset 206, chemical observational dataset 208, and/or biological observational dataset 210). During training stage 230, evaluation apparatus 124 determines model parameters 242 for a statistical and/or machine learning model that maps between lower-spatial-resolution historical data points in climate projection dataset 204 and higher-spatial-resolution historical data points in the observational dataset(s).

During inference stage 232, evaluation apparatus 124 uses model parameters 242 to convert low-resolution data points spanning future periods from climate projection dataset 204 into downscaled outputs 244 that correspond to higher-resolution climate projections. After downscaled outputs 244 are generated, processing apparatus 122 performs climatology addition 216 to add climatology components extracted from time series data in one or more observational datasets (e.g., physical observational dataset 206, chemical observational dataset 208, and/or biological observational dataset 210) to downscaled outputs 244. The operation of processing apparatus 122 and evaluation apparatus 124 in generating a high-resolution climate projection from ocean climate data is described in further detail below with respect to FIG. 4B.

It will be appreciated that a variety of techniques can be used by evaluation apparatus 124 to perform bias correction 222 and/or statistical downscaling 224. These techniques can include (but are not limited to) a quantile mapping technique, a detrended quantile mapping technique, a stacked super-resolution convolutional neural network (SRCNN), and/or an Inter-Sectoral Impact Model Intercomparison Project phase 3 bias adjustment and statistical downscaling method (ISIMIP3BASD).

The output of climatology addition 216 includes a high-resolution climate projection that can be used in local climate impact assessments, site selection, agriculture, water resource management, risk management, and/or other impact studies. The high-resolution climate projection can also, or instead, be used to generate one or more visual representations of data points in the high-resolution climate projection across time and/or spatial dimensions. For example, the high-resolution climate projection may be used to generate a visualization of distributions and trends for different variables in the high-resolution climate projection. The visualization may include a geographic heat map of values associated with a given variable (e.g., temperature, current velocity, light irradiance, sea ice thickness, sea ice concentration, chemical solution composition, biological composition, salinity, pH, heat wave frequency, water quality, wave height, etc.) at a certain time and/or over a certain time period. The visualization may also, or instead, include one or more tables, charts, plots, three-dimensional (3D) visualizations, and/or other types of visual representations of projected changes in one or more variables in the high-resolution climate projection.

FIG. 3 illustrates an example process for performing grid standardization 212 of ocean climate data in accordance with the disclosed embodiments. As shown in FIG. 3, the example grid standardization 212 is performed on three groupings of data: low-resolution climate projection data 302 (e.g., from climate projection dataset 204 of FIG. 2), high-resolution physical observational data 304 (e.g., from physical observational dataset 206), and intermediate-resolution chemical/biological observational data 306 (e.g., from chemical observational dataset 208 and/or biological observational dataset 210).

Low-resolution climate projection data 302 includes climate data from a GCM with a relatively low spatial resolution. For example, low-resolution climate projection data 302 may include data points associated with grid cells that have a spatial resolution of one degree in spherical Earth coordinates.

High-resolution resolution physical observational data 304 includes physical observations and/or measurements at a relatively high spatial resolution. For example, high-resolution physical observational data 304 may include data points associated with grid cells that have a spatial resolution of 1/12 degree in spherical Earth coordinates.

Intermediate-resolution chemical/biological observational data 306 includes chemical and/or biological physical observations and/or measurements at a spatial resolution that is in between the spatial resolution of low-resolution climate projection data 302 and the spatial resolution of high-resolution physical observational data 304. For example, intermediate resolution chemical/biological observational data 306 may include data points associated with grid cells that have a spatial resolution of ¼ degree.

Grid standardization 212 begins with a spherical grid extrapolation 312 of low-resolution climate projection data 302, as well as a separate spherical grid extrapolation 314 of intermediate-resolution chemical/biological observational data 306. Spherical grid extrapolations 312 and 314 involve extrapolating low-resolution climate projection data 302 and intermediate-resolution chemical/biological observational data 306, respectively, into grid points with higher spatial resolution. For example, spherical grid extrapolation 312 may be used to extrapolate low-resolution climate projection data 302 at a spatial resolution of one degree to a grid of cells with a spatial resolution of ½ degree. In another example, spherical grid extrapolation 314 may be used to extrapolate intermediate-resolution chemical/biological observational data 306 at a spatial resolution of ¼ degree to a grid of cells with a spatial resolution of 1/12 degree, which matches the spatial resolution of high-resolution physical observational data 304.

In some embodiments, spherical grid extrapolations 312 and/or 314 are performed using an inverse distance weighted average, in which the valuate of each extrapolated “destination” data point is set to the weighted average of N (where N≥1) closest “source” points in the corresponding grouping of data (e.g., low-resolution climate projection data 302 or intermediate-resolution chemical/biological observational data 306). Each source data point used in the weighted average can be weighted by the reciprocal of the distance (e.g., as measured on the Earth's sphere) between the source data point and the destination data point raised to a power P (where P≥1). One or both spherical grid extrapolations 312 and/or 314 may also, or instead, be performed using other techniques, such as (but not limited to) nearest neighbors and/or iterative averaging of neighboring points.

Next, grid standardization 212 includes regridding 316 of data points from spherical grid extrapolation 312 to produce higher-resolution climate projection data 322, as well as a separate regridding 318 of data points from high-resolution physical observational data 304 and data points from spherical grid extrapolation 314 to produce higher-resolution observational data 324. Regridding 316 and 318 can be used to convert data from one spatial resolution and/or coordinate system to another spatial resolution and/or coordinate system. For example, regridding 316 may be performed using bilinear interpolation, first-order conservative interpolation, and/or another interpolation technique.

Regridding 316 and/or 318 may allow datasets with different resolutions and/or coordinate systems to be compared and/or further processed under a “standard” or “canonical” resolution and/or coordinate system. For example, regridding 316 and/or 318 may be used to transform 0.5-degree resolution data from spherical grid extrapolation 312, 1/12-degree resolution data from spherical grid extrapolation 314, and high-resolution physical observational data 304 at 1/12-degree resolution into the same spherical Earth coordinate system.

While grid standardization 212 has been described above with respect to spherical grid extrapolation 312 and regridding 316 of low-resolution climate projection data 302 into higher-resolution climate projection data 322, spherical grid extrapolation 314 and regridding 318 of intermediate-resolution chemical/biological observational data 306 into higher-resolution observational data 324, and regridding 318 of high-resolution physical observational data 304 into higher-resolution observational data 324, it will be appreciated that different combinations of spherical grid extrapolation and regridding can be applied to different sets and/or groupings of data to adjust the spatial resolutions, origins, and/or coordinate systems associated with the data. For example, spherical grid extrapolation and regridding may be used with both high-resolution physical observational data 304 and intermediate-resolution chemical/biological observational data 306 to convert both groupings of data into the same spatial resolution of 1/64 degree by 1/64 degree. In another example, spherical grid extrapolation and/or regridding may be used to convert high-resolution physical observational data 304 and/or intermediate-resolution chemical/biological observational data 306 into a spatial resolution of one degree to match that of low-resolution climate projection data 302. The lower-resolution observational data can then be used to detect and adjust biases in low-resolution climate projection data 302, as discussed above.

FIG. 4A illustrates an example process for performing trend-preserving climatology removal 214 in ocean climate data in accordance with the disclosed embodiments. As shown in FIG. 4A, input into trend-preserving climatology removal 214 includes a multidimensional time series 402. As mentioned above, multidimensional time series 402 may be generated by combining data points from one or more observational datasets (e.g., physical observational dataset 206, chemical observational dataset 208, biological observational dataset 210, etc.) that span multiple years into a period that spans a single month. For example, multidimensional time series 402 may include temperature values that are sampled and/or predicted across latitude, longitude, depth, and time within a region over the time period of 1990-2100. These temperature values may be combined into a period spanning a single month. Within this period, the temperature values may be ordered by the days of the month on which the temperature values were collected.

During trend-preserving climatology removal 214, trend removal 412 is performed on multidimensional time series 402 to extract one or more trend 404 components from multidimensional time series 402. For example, trend removal 214 may be performed by computing (i) an annual average for each year of data in multidimensional time series 402 and (ii) an “overall” average as an average of all annual averages. A value of trend 404 for a given year may then be computed as the overall average subtracted from the average for that year. The value of trend 404 for each year may then be subtracted from all data points in that year.

Next, climatology removal 414 is performed to remove one or more climatology 406 components from the trendless multidimensional time series outputted by trend removal 412. For example, climatology removal 414 may be performed by computing (i) a “global” average of all data points in the trendless multidimensional time series and (ii) a “time step” average of all data points in the trendless multidimensional time series that correspond to a given time step (e.g., an hour, a day, etc.) within a calendar year. The global average may be subtracted from each time step average to produce a corresponding climatology 406 that spans a calendar year. Climatology 406 values may then be subtracted from data points that occupy the corresponding time steps within the trendless multidimensional time series to produce a trendless anomaly time series 408.

Trend addition 416 is then performed to combine trendless anomaly time series 408 and trend 404 into anomaly time series 218. This step can involve summing data points in trendless anomaly time series 408 with corresponding data points in trend 404.

While trend-preserving climatology removal 214 is discussed above with respect to a specific ordering and/or technique for performing trend removal 412, climatology removal 414, and/or trend addition 416, it will be appreciated that other combinations of steps and/or techniques for performing individual steps can be used to implement the functionality of trend-preserving climatology removal 214. For example, trend removal 214 may be performed using differencing, regression, moving average, decomposition, filtering, and/or other techniques. In another example, climatology removal 414 may be performed using climatology 406 that is computed for a different time period (e.g., individual months, a single month across all years, etc.). In a third example, one or more of trend removal 412, climatology removal 414, and/or trend addition 416 may be omitted, repeated, and/or performed in a different order during trend-preserving climatology removal 214.

FIG. 4B illustrates an example process for generating a climate projection 442 from one or more sets of ocean climate data in accordance with the disclosed embodiments. As mentioned above, the process of generating climate projection 442 can involve operations performed by both processing apparatus 122 and evaluation apparatus 124.

In the example process of FIG. 4B, processing apparatus 122 uses trend-preserving climatology removal 214 to convert high-resolution historical observational data 422 into an observational anomaly time series 432. For example, processing apparatus 122 may generate a trend-preserved observational anomaly time series 432 by applying trend removal, climatology, and/or trend addition to high-resolution historical observational data 422 from one or more observational datasets (e.g., physical observational dataset 206, chemical observational dataset 208, biological observational dataset 210, etc.) after grid standardization 212 has been applied to the observational dataset(s). Processing apparatus 122 can also retain observational climatology data 426 that is generated during trend-preserving climatology removal 214 of high-resolution historical observational data 422.

Processing apparatus 122 also uses trend-preserving climatology removal 214 to convert low-resolution climate projection data 424 into a projection anomaly time series 434. For example, processing apparatus 122 may generate a trend-preserved projection anomaly time series 434 by applying trend removal, climatology, and/or trend addition to historical low-resolution climate projection data 424 from climate projection dataset 204 after grid standardization 212 has been applied to climate projection dataset 204.

Next, evaluation apparatus 124 uses observational anomaly time series 432 and projection anomaly time series 434 to perform training 436 that computes and/or updates model parameters 242 of a model for performing bias correction 222 and/or statistical downscaling 224. For example, evaluation apparatus 124 may perform training 436 to learn a transfer function, neural network, and/or another representation of statistical relationships between observational anomaly time series 432 and projection anomaly time series 434. Evaluation apparatus 124 can optionally use model parameters 242 to bias-correct and/or downscale some or all historical data points in projection anomaly time series 434.

After training 436 is complete, evaluation apparatus 124 uses model parameters 242 to perform inference 438 that generates an anomaly projection 440 from projection anomaly time series 434. This anomaly projection 440 can correspond to downscaled outputs 244 in FIG. 2. Continuing with the above example, evaluation apparatus 124 may use trained model parameters 242 of the transfer function, neural network, and/or another representation of statistical relationships between observational anomaly time series 432 and projection anomaly time series 434 to generate anomaly projection 440 by bias-correcting and/or downscaling some or all data points in projection anomaly time series 434 that span a future period. When bias correction is used to generate anomaly projection 440, anomaly projection 440 can have a spatial resolution that is similar to that of projection anomaly time series 434. When statistical downscaling is used to generate anomaly projection 440, anomaly projection 440 can have a spatial resolution that is higher than that of projection anomaly time series 434.

Finally, processing apparatus 122 performs climatology addition 216 to combine anomaly projection 440 and observational climatology data 426 into climate projection 442. For example, processing apparatus 122 may reverse the steps performed in trend-preserving climatology removal 214 to perform climatology addition 216 that incorporates observational climatology data 426 into anomaly projection 440. The resulting climate projection 442 can then be used to perform impact studies and/or generate visualizations, as discussed above.

In some embodiments, climate projection 442 is used to evaluate and/or predict habitat quality for various marine organisms. More specifically, climate projection 442 can include multidimensional data points that specify physical, chemical, biological, and/or other variables associated with ocean climate for specific locations (e.g., latitudes, longitudes, and depths) and times (e.g., future dates and/or times). Some or all of these variables can be used to determine the quality of a habit for a given species at a certain location (e.g., a range of latitudes, longitudes, and/or depths) and/or time (e.g., a point in the future, a future period, etc.).

To assess the habitat quality of a given species at a certain location and/or time, a subset of data points in climate projection 442 that match the location and/or time can be combined with tolerance distributions of the species for the corresponding variables (e.g., temperature, pH, oxygen level, etc.) into a set of species-specific tolerances. For example, each tolerance distribution may include a range of values for a given variable (e.g., temperature) that can be tolerated by a fish species and/or the relative tolerance of the fish species to various temperatures within that range. The tolerance distribution may be used to map each temperature within climate projection 442 that matches a specified location and/or time into a range of [0,1] that represents the relative tolerance of the fish species to that temperature.

Tolerances of the species to different variables can then be aggregated by location and/or time into a set of habitat quality scores for the species. Continuing with the above example, tolerances of the fish species to temperature, pH, oxygen level, and/or other variables at a given location and time may be multiplied and/or otherwise combined to produce a habitat quality score for that location and time.

Habitat quality scores for the species can then be used to generate a habitat quality projection for the species. Continuing with the example, habitat quality scores for multiple locations within a geographic region and a specific time may be included in a multidimensional projection of habitat quality for the fish species for that geographic region and time. This multidimensional projection can then be used to generate visualizations (e.g., geographic heat maps, charts, plots, etc.), evaluate shifts in habitat over time, assess risks associated with farmed and/or wild populations of the species, develop strategies to protect and manage vulnerable habitats, and/or perform other analyses or actions.

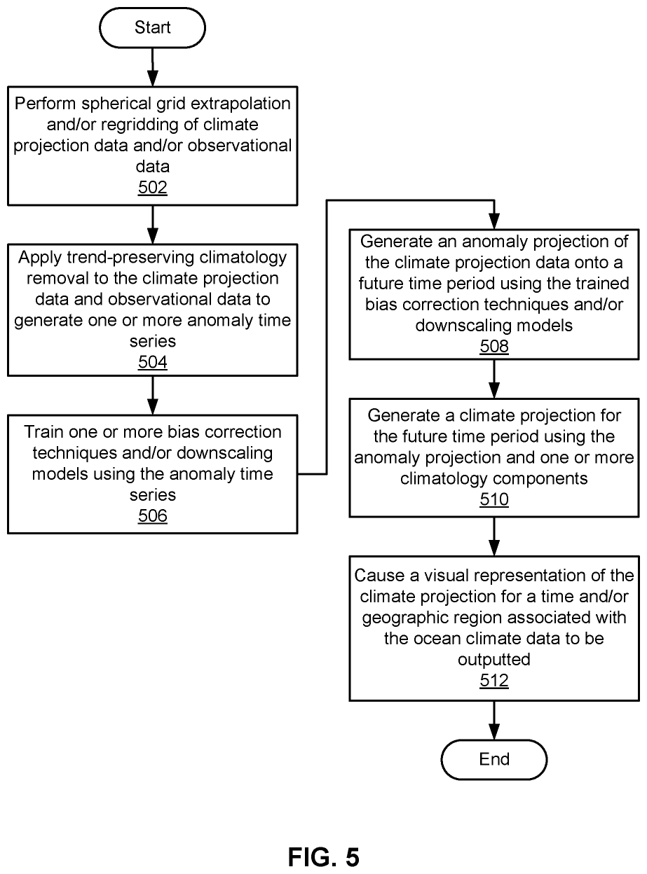

FIG. 5 shows a flowchart of method steps for processing ocean climate data in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, spherical grid extrapolation and/or regridding of climate projection data and/or observational data is performed (operation 502). For example, spherical grid extrapolation and regridding may be used to convert low-resolution climate projection data into higher-resolution climate projection data and/or convert intermediate-resolution chemical and/or biological observational data into higher-resolution observational data. Regridding of some or all of the extrapolated data may also be performed to transform the extrapolated data into the same canonical coordinate system. In another example, spherical grid extrapolation and/or regridding may be used to convert higher-resolution observational data into lower-resolution observational data that can be used to bias-correct lower-resolution climate projection data.

Next, trend-preserving climatology removal is applied to the climate projection data and observational data to generate one or more anomaly time series (operation 504). Continuing with the above example, trend-preserving climatology removal may be applied separately to the climate projection data and observational data. The trend-preserving climatology removal may include removing a trend component from a time series to generate a detrended time series, removing a climatology component from the detrended time series to generate a trendless anomaly time series, and adding the trend component back to the trendless anomaly time series to generate a corresponding anomaly time series.

One or more bias correction techniques and/or downscaling models are also trained using the anomaly time series (operation 506). For example, operation 506 may be used to learn a transfer function, neural network, and/or another representation of statistical relationships between one or more anomaly time series generated from historical observational data and one or more anomaly time series generated from historical climate projection data. This representation can optionally be used to bias correct and/or downscale some or all historical data points in the anomaly time series generated from climate projection data.

An anomaly projection of the climate projection data onto a future time period is then generated using the trained bias correction techniques and/or downscaling models (operation 508). Continuing with the above example, the transfer function, neural network, and/or another representation of statistical relationships between observational data and climate projection data may be used to bias-correct and/or downscale some or all data points that span the future time period within the anomaly time series of climate projection data.

A climate projection for the future time period is subsequently generated using the anomaly projection and one or more climatology components (operation 510). For example, a climatology addition process may be used to compute the climate projection by adding climatology component(s) from the observational data to the anomaly projection. The climatology addition process may be carried out by performing the steps in the trend-preserving climatology removal process in reverse order.

Finally, a visual representation of the climate projection for a time and/or geographic region associated with the ocean climate data is caused to be outputted (operation 512). For example, the climate projection and/or a habitat analysis associated with the climate projection may be stored and/or transmitted. The climate projection and/or habitat analysis may also be used to generate a table, chart, plot, geographic heat map, temporal heat map, and/or another visualization of the data in the climate projection and/or habitat analysis. In another example, climate projections may be generated using multiple bias correction and/or downscaling techniques. These climate projections may also be compared and used to generate reports, visualizations, and/or other outputs related to assessing and/or characterizing inter-model variability in the corresponding bias correction and/or downscaling techniques.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for processing ocean climate data, comprising:
converting the ocean climate data into one or more climatology components and one or more anomaly time series;
training one or more bias correction techniques using the one or more anomaly time series;
generating, using the one or more trained bias correction techniques, an anomaly projection of the ocean climate data onto a future time period;
generating a climate projection for the future time period using the anomaly projection and the one or more climatology components; and
causing a visual representation of the climate projection for a geographic region associated with the ocean climate data to be outputted.

2. The method of claim 1, further comprising generating at least a portion of the ocean climate data by converting a first set of data points associated with a first resolution into a second set of data points associated with a second resolution that is higher than the first resolution, wherein each data point in the second set of data points is computed based on a weighted average of a subset of the first set of data points that is closest to a location associated with the data point.

3. The method of claim 1, further comprising generating at least a portion of the ocean climate data by transforming a first plurality of datasets associated with a plurality of resolutions into a second plurality of datasets associated with a single resolution and a single coordinate system.

4. The method of claim 1, further comprising generating at least a portion of the ocean climate data by converting a first set of data points associated with a first resolution into a second set of data points associated with a second resolution that is lower than the first resolution.

5. The method of claim 1, wherein converting the ocean climate data into the one or more climatology components and the one or more anomaly time series comprises:
computing a first climatology component and a first anomaly time series from a first dataset in the ocean climate data; and
computing a second climatology component and a second anomaly time series from a second dataset in the ocean climate data.

6. The method of claim 5, wherein the first dataset comprises a climate projection dataset and the second dataset comprises an observational dataset.

7. The method of claim 1, wherein converting the ocean climate data into the one or more climatology components and the one or more anomaly time series comprises:
removing one or more trend components from the ocean climate data to generate detrended ocean climate data;
removing the one or more climatology components from the detrended ocean climate data to generate one or more trendless anomaly time series; and
adding the one or more trend components to the one or more trendless anomaly time series to generate the one or more anomaly time series.

8. The method of claim 1, wherein generating the climate projection for the future time period comprises adding the one or more climatology components to the anomaly projection.

9. The method of claim 1, further comprising:
converting a plurality of sets of data points in the climate projection for a plurality of locations in the geographic region into a plurality of species-specific tolerances for the plurality of locations; and
generating a habitat quality projection for the geographic region based on an aggregation of the plurality of species-specific tolerances.

10. The method of claim 1, further comprising:
training one or more downscaling models using the one or more anomaly time series; and
generating, using the one or more trained downscaling models, an additional anomaly projection of the ocean climate data onto the future time period, wherein the climate projection is further generated based on the additional anomaly projection.

11. The method of claim 1, wherein the ocean climate data comprises at least one of a current velocity, a sea ice thickness, a sea ice concentration, a chemical solution composition, a biological composition, a salinity, a pH, a heat wave frequency, a water quality, or a wave height.

12. The method of claim 1, wherein the one or more bias correction techniques comprise at least one of a machine learning model or a detrended quantile mapping bias correction technique.

13. The method of claim 1, wherein the one or more climatology components comprise an average deviation of a monthly average value from a corresponding annual average value.

14. The method of claim 1, wherein the visual representation comprises a heat map for the geographic region.

15. One or more non-transitory computer-readable storage media storing instructions that, when executed by one or more processors, cause the one or more processors to perform a method, the method comprising:
converting ocean climate data into one or more climatology components and one or more anomaly time series;
training one or more bias correction techniques using the one or more anomaly time series;
generating, using the one or more trained bias correction techniques, an anomaly projection of the ocean climate data onto a future time period;
generating a climate projection for the future time period using the anomaly projection and the one or more climatology components; and
causing a visual representation of the climate projection for a geographic region associated with the ocean climate data to be outputted.

16. The one or more non-transitory computer-readable storage media of claim 15, wherein the method further comprises:
training one or more downscaling models using the one or more anomaly time series; and
generating, using the one or more trained downscaling models, an additional anomaly projection of the ocean climate data onto the future time period, wherein the climate projection is further generated based on the additional anomaly projection.

17. The one or more non-transitory computer-readable storage media of claim 15, wherein the method further comprises:
converting a plurality of sets of data points in the climate projection into a plurality of species-specific tolerances using a plurality of tolerance distributions for a species;
aggregating the plurality of species-specific tolerances into a plurality of habitat quality scores based on one or more locations associated with the plurality of species-specific tolerances; and
generating a habitat quality projection for the species based on the plurality of habitat quality scores.

18. The one or more non-transitory computer-readable storage media of claim 15, wherein the visual representation comprises a heat map of habitat quality for the geographic region.

19. The one or more non-transitory computer-readable storage media of claim 15, wherein the ocean climate data comprises at least one of a low resolution climate projection dataset, a high resolution observational dataset of physical values, or an intermediate resolution observational dataset of biological values.

20. A system, comprising:
one or more processors; and
memory storing instructions that, when executed by the one or more processors, cause the system to perform operations comprising:
converting ocean climate data into one or more climatology components and one or more anomaly time series;
training one or more downscaling models using the one or more anomaly time series;
generating, using the one or more trained downscaling models, an anomaly projection of the ocean climate data onto a future time period;
generating a climate projection for the future time period using the anomaly projection and the one or more climatology components; and
causing a visual representation of the climate projection for a geographic region associated with the ocean climate data to be outputted.
